(19) United States
(12) Patent Application Publication
(10) Pub. No.: US 2018/0038992 A1
(43) Pub. Date: Feb. 8, 2018

(54) Automatic Petro-Physical Log Quality Control

(71) Applicant: Saudi Arabian Oil Company, Dhahran (SA)

(72) Inventors: Robin M. Macdonald, Dhahran (SA); Muhammad S. Al-Readean, Dhahran (SA); Charles M. Bradford, Dhahran (SA); Alan Patrick Hibler, Dhahran (SA)

(21) Appl. No.: 15/229,352

(22) Filed: Aug. 5, 2016

(51) Int. Cl. G01V 11/00

(52) U.S. Cl. CPC G01V 11/002

(57) ABSTRACT

Software-based quality control analysis of well log data. At least some of the various embodiments are computer-readable mediums storing a program that, when executed by a processor, causes the processor to read data from a well log, and perform a quality control analysis on the data.

### TECHNICAL FIELD

Example embodiments relate to a software-based quality control analysis of well log data. At least some of the various embodiments are computer-readable mediums storing a program that, when executed by a processor, causes the processor to read data from a well log, and perform a quality control analysis on the data.

### BACKGROUND

During the life of a hydrocarbon producing well (e.g., oil well or natural gas well), the well may be the subject of multiple “logging” operations. Well logging is the process of recording various physical, chemical, electrical, or other properties of the rock or fluid mixtures penetrated by drilling a borehole into the earth's crust. In the oil and gas industry, the term “wireline” usually refers to a cabling technology used by operators of oil and gas wells to lower equipment or measurement devices into the well for the purposes of well intervention, reservoir evaluation, and pipe recovery. There are many types of wireline logs and they can be categorized either by their function or by the technology that they use. “Open hole logs” are run before the oil or gas well is lined with pipe or cased. “Cased hole logs” are run after the well is lined with casing or production pipe.

In other words well logging may take place while drilling, during the drilling process but with the drill string removed, or after the well is completed and has a casing installed. After each logging operation, the one or more logs produced are reviewed by a human analyst. In particular, the analyst reviews the log data, and compares information in the log data to a set of criteria to determine if the log data is in tolerance or out of tolerance with the preset criteria. Such a review is known as performing quality control on the well. Performing human-based quality control analysis of the log data is very time consuming as in most logs the data may comprise 350 or more data points. In some cases, the human-based interpretation and/or comparison of the well information may take from two to four man-days to complete for each well.

More recently, logging while drilling (LWD) has been used. LWD is a technique of conveying well logging tools into the well borehole downhole as part of the bottom hole assembly (BHA). LWD tools work with a measurement while drilling (MWD) system to transmit partial or complete measurement results to the surface via typically a drilling mud pulser or other improved techniques, while LWD tools are still in the borehole, which is called “real-time data”. Complete measurement results can be downloaded from LWD tools after they are pulled out of hole, which is called “memory data”.

LWD, while sometimes risky and expensive, has the advantage of measuring properties of a formation before drilling fluids invade deeply. Further, many wellbores prove to be difficult or even impossible to measure with conventional wireline tools, especially highly deviated wells. In these situations, the LWD measurement ensures that some measurement of the subsurface is captured in the event that wireline operations are not possible. Timely LWD data can also be used to guide well placement so that the wellbore remains within the zone of interest or in the most productive portion of a reservoir, such as in highly variable shale reservoirs.

### SUMMARY

Accordingly, example embodiments relate to systems, methods, and computer programs for determining the quality of well log data received from a hydrocarbon well based on the availability, completeness, consistency, integrity, and validity of the well log data relating to a plurality of log families.

One example embodiment is a quality control system for monitoring data quality of well log data from a hydrocarbon well. The system includes one or more processors operatively coupled to a control unit associated with the hydrocarbon well, and a non-transitory computer-readable medium in communication with the one or more processors and having stored thereon a set of instructions that when executed cause the one or more processors to perform operations including receiving well log data pertaining to a plurality of log families from the hydrocarbon well, performing a plurality of tests on well log data from each of the plurality of log families, determining one or more quality dimensions of the well log data from each of the plurality of log families based on results of the plurality of tests, and generating line quality control data based on the one or more quality dimensions of the well log data from each of the plurality of log families.

The instructions may further cause the one or more processors to perform operations including receiving the line quality control data from analysis of the well log data, and generating statistical data showing quality of the well log data. The instructions may further cause the one or more processors to perform operations including generating a graphical illustration displaying data issues in the received well log data. The well log data may include at least one of wireline log data and logging-while-drilling log data. The plurality of tests may include a single log analysis or a cross-log analysis of the received well log data. The single log analysis may include at least one of a range analysis, a spike analysis, a bad hole analysis, a repeated values analysis, an excessive correction analysis, a missing values analysis, and a rugosity analysis. The cross-log analysis may include at least one of an order of logs analysis, an availability of combination of logs analysis, and a composite log validation analysis. The plurality of log families may include a value from a neutron log, a sonic log, a gamma ray log, a resistivity log, or a density log. The one or more quality dimensions may include at least one of completeness, consistency, validity, integrity, and availability.

Another example embodiment is a method for monitoring data quality of well log data from a hydrocarbon well. The method may include receiving, by one or more processors coupled to a control unit associated with the hydrocarbon well, well log data pertaining to a plurality of log families from the hydrocarbon well, performing a plurality of tests on well log data from each of the plurality of log families, determining one or more quality dimensions of the well log data from each of the plurality of log families based on results of the plurality of tests, and generating line quality control data based on the one or more quality dimensions of the well log data from each of the plurality of log families. The method may also include receiving, by the one or more processors, the line quality control data from analysis of the well log data, and generating statistical data showing quality of the well log data.

Another example embodiment is a non-transitory computer-readable medium including instructions stored thereon, which when executed by one or more processors operatively coupled the computer-readable medium, cause the one or more processors to perform operations including receiving well log data pertaining to a plurality of log families from the hydrocarbon well, performing a plurality of tests on well log data from each of the plurality of log families, determining one or more quality dimensions of the well log data from each of the plurality of log families based on results of the plurality of tests, and generating line quality control data based on the one or more quality dimensions of the well log data from each of the plurality of log families.

The instructions may further cause the one or more processors to perform operations including receiving the line quality control data from analysis of the well log data, and generating statistical data showing quality of the well log data. The instructions may further cause the one or more processors to perform operations including generating a graphical illustration displaying data issues in the received well log data. The well log data may include at least one of wireline log data and logging-while-drilling log data. The plurality of tests may include a single log analysis or a cross-log analysis of the received well log data. The single log analysis may include at least one of a range analysis, a spike analysis, a bad hole analysis, a repeated values analysis, an excessive correction analysis, a missing values analysis, and a rugosity analysis. The cross-log analysis may include at least one of an order of logs analysis, an availability of combination of logs analysis, and a composite log validation analysis. The plurality of log families may include a value from a neutron log, a sonic log, a gamma ray log, a resistivity log, or a density log. The one or more quality dimensions may include at least one of completeness, consistency, validity, integrity, and availability.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a block diagram showing an embodiment of a quality control system, according to one or more example embodiments of the disclosure.

FIG. 2 is a diagram showing an embodiment of a wireline system, according to one or more example embodiments of the disclosure.

FIG. 3 is a diagram showing an embodiment of a drilling rig system, according to one or more example embodiments of the disclosure.

FIG. 4 illustrates example operations in an example method for performing quality control analysis, according to one or more example embodiments of the disclosure.

FIG. 5 illustrates example operations in an example method for performing quality control analysis, according to one or more example embodiments of the disclosure.

FIG. 6 illustrates a data quality dimension model adopted in a data quality check, according to one or more example embodiments of the disclosure.

FIG. 7 illustrates different levels of data profiling on which data quality tests may be applied, according to one or more example embodiments of the disclosure.

FIG. 8 illustrates the representation of composite quality checks, according to one or more example embodiments of the disclosure.

FIG. 9A illustrates sonic logging quality checks, according to one or more example embodiments of the disclosure.

FIG. 9B illustrates neutron logging quality checks, according to one or more example embodiments of the disclosure.

FIGS. 9C-E illustrate resistivity logging quality checks, according to one or more example embodiments of the disclosure.

FIGS. 9F-H illustrate density logging quality checks, according to one or more example embodiments of the disclosure.

FIGS. 9I-J illustrate gamma ray logging quality checks, according to one or more example embodiments of the disclosure.

FIG. 10A illustrates data quality dimension measurements in well logging groups, according to one or more example embodiments of the disclosure.

FIG. 10B illustrates a histogram showing data quality issues with microspherical focused resistivity log data, according to one or more example embodiments of the disclosure.

FIG. 11 illustrates a visual layout of well logs with quality issues, according to one or more example embodiments of the disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

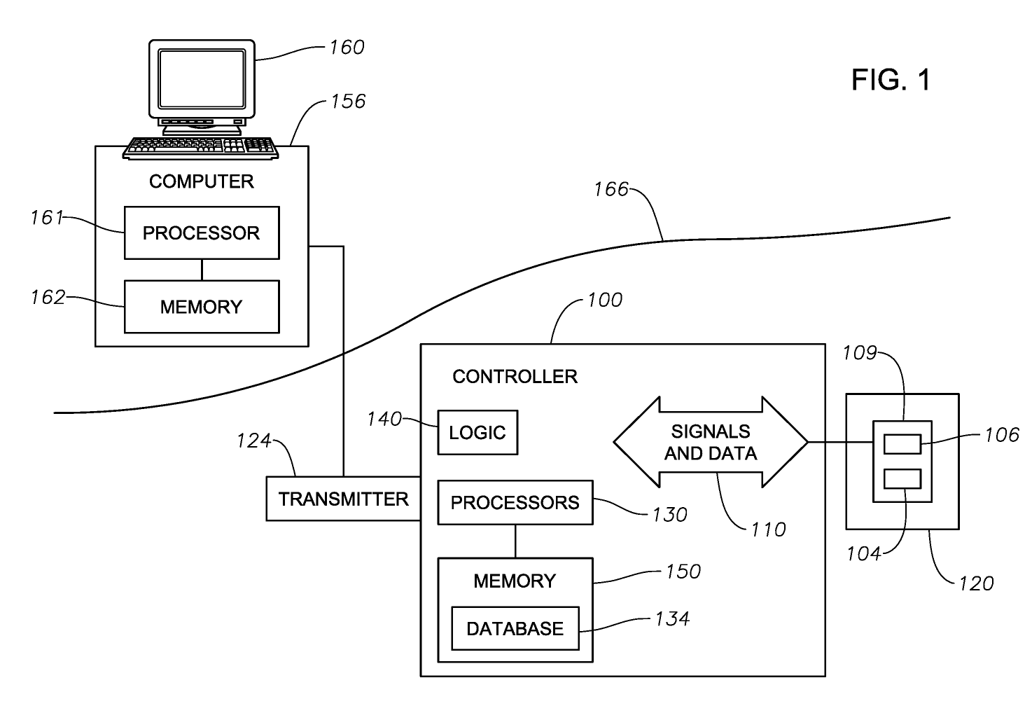

FIG. 1 is a block diagram showing a quality control system in accordance with one or more example embodiments. The system of FIG. 1 is for purposes of illustration only as the logging tool can have different quantities of transducers/receivers, different tools can be used in the system, and/or the system can incorporate different controllers depending on the type of tool implemented. The system can include a combination of one or more down hole tools 109, and one or more controllers 100. Either one of the tool 109 and/or the controller 100 can be located inside or outside of a tool body 120 or attached to the outside of the tool body 120. The tool 109 may include one or more sensors or transducers 102 and one or more transmitters 104. The tool 109 can further comprise one or more receivers 106. A controller 100 can be coupled to the tool 109 for controlling operation of the tool 109 (e.g., transmission of signals) as well as retrieving data from the tool 109. The data can include sensor data that may be categorized into one or more log families including, but not limited to, a neutron log, a sonic log, a gamma ray log, a resistivity log, or a density log.

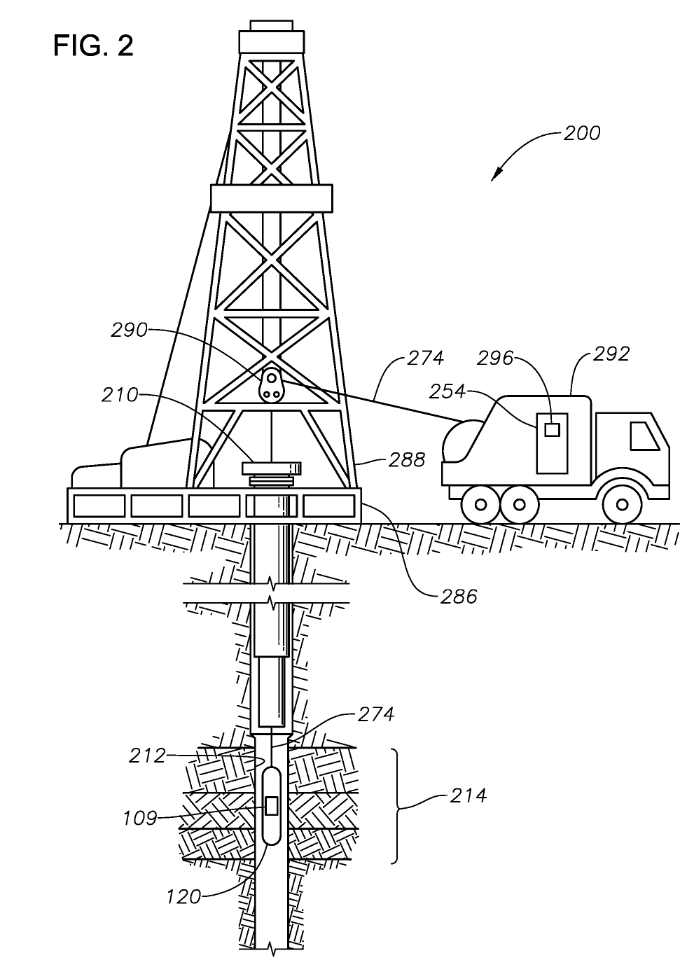

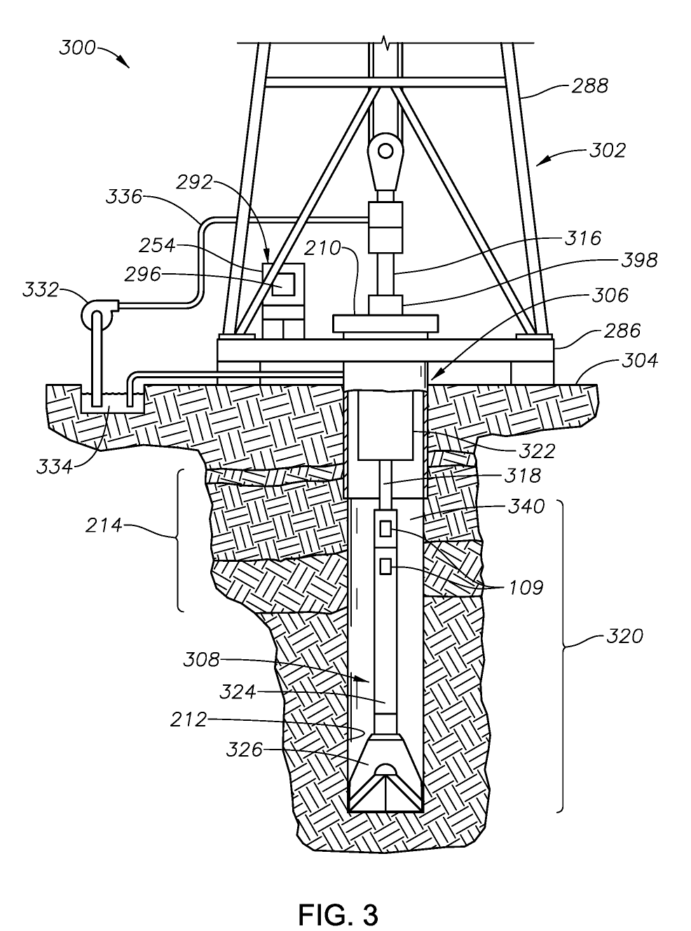

The controller 100 can comprise a programmable drive and/or sampling control system. The controller can include logic 140 for acquiring sensor data and/or signals 110 from the tool 109. Memory 150, located inside or outside the tool body 120, can be used to store acquired data, and/or processing results (e.g., perhaps in a database 134). The memory 150 is communicatively coupled to the processor(s) 130. While not shown in FIG. 1, it should be noted that the memory 150 may be located down hole, or above the surface of the geological formations 166. A data transmitter 124 may be used to transmit data and/or signals to the surface 166 for display by the quality control system as illustrated in FIGS. 2-3. Thus, the system may include the data transmitter 124 (e.g., a telemetry transmitter) to transmit the data to a surface data processing computer 156.

The system can further include a computer 156 coupled to and configured to communicate with, control, and/or display data received from the controller 100. The computer 156 can include a processor 161 and memory 162 for controlling the system. A monitor 160 can be coupled to the computer for displaying data that can include sensor data, transformed (e.g., filtered) sensor data, and/or quality control data. The computer 156 can be configured to execute the various methods for collection and display of elected sensor data for integrated quality control.

FIG. 2 is a diagram showing an embodiment of a wireline system in accordance with various embodiments and FIG. 3 is a diagram showing an embodiment of a drilling rig system in accordance with various embodiments. Thus, the systems 200, 300 may include portions of a wireline logging tool body 120, as part of a wireline logging operation, or of a down hole tool 324, as part of a down hole drilling operation. The tool of FIG. 1 can be used in either system 200, 300 and the quality control workflow results discussed in the following paragraphs can be used to effect changes in either operation.

FIG. 2 shows a well during wireline logging operations. A drilling platform 286 is equipped with a derrick 288 that supports a hoist 290. Drilling of hydrocarbon (oil and gas) wells is commonly carried out using a string of drill pipes connected together so as to form a drilling string that is lowered through a rotary table 210 into a wellbore or borehole 212. Here it is assumed that the drilling string has been temporarily removed from the borehole 212 to allow a wireline logging tool body 120, such as a probe, to be lowered by wireline or logging cable 274 into the borehole 212. Typically, the wireline logging tool body 270 is lowered to the bottom of the region of interest and subsequently pulled upward at a substantially constant speed.

During the upward trip, at a series of depths, the instruments (e.g., the transducers 104 and receivers 107 FIG. 1) included in the tool body 120 may be used to perform measurements on the subsurface geological formations 214 adjacent the borehole 212 (and the tool body 120). The received data, that can include sensor data, can be communicated to a surface logging facility 292 for storage, processing, and/or analysis as described previously. The logging facility 292 may be provided with electronic equipment for various types of signal processing. Similar formation evaluation data may be gathered and analyzed during drilling operations (e.g., during LWD operations, and by extension, sampling while drilling).

In some embodiments, the tool body 120 comprises an acoustic tool for obtaining and analyzing acoustic measurements from a subterranean geological formation through a wellbore. The tool is suspended in the wellbore by a wireline cable 274 that connects the tool to a surface control unit (e.g., comprising a workstation 254). The tool may be deployed in the wellbore on coiled tubing, jointed drill pipe, hard wired drill pipe, or any other suitable deployment technique.

Turning now to FIG. 3, it can be seen how a system 300 may also form a portion of a drilling rig 302 located at the surface 304 of a well 306. The drilling rig 302 may provide support for a drill string 308. The drill string 308 may operate to penetrate a rotary table 210 for drilling a borehole 212 through subsurface formations 214. The drill string 308 may include a Kelly 316, drill pipe 318, and a bottom hole assembly 320, perhaps located at the lower portion of the drill pipe 318. The bottom hole assembly 320 may include drill collars 322, a down hole tool 109, and a drill bit 326. The drill bit 326 may operate to create a borehole 212 by penetrating the surface 304 and subsurface formations 214. The down hole tool 324 may comprise any of a number of different types of tools including MWD tools, LWD tools, and others.

During drilling operations, the drill string 308 (perhaps including the Kelly 316, the drill pipe 318, and the bottom hole assembly 320) may be rotated by the rotary table 210. In addition to, or alternatively, the bottom hole assembly 320 may also be rotated by a motor (e.g., a mud motor) that is located down hole. The drill collars 322 may be used to add weight to the drill bit 326. The drill collars 322 may also operate to stiffen the bottom hole assembly 320, allowing the bottom hole assembly 320 to transfer the added weight to the drill bit 326, and in turn, to assist the drill bit 326 in penetrating the surface 204 and subsurface formations 214.

During drilling operations, a mud pump 332 may pump drilling fluid (sometimes known by those of ordinary skill in the art as “drilling mud”) from a mud pit 334 through a hose 336 into the drill pipe 318 and down to the drill bit 326. The drilling fluid can flow out from the drill bit 326 and be returned to the surface 304 through an annular area 340 between the drill pipe 318 and the sides of the borehole 212. The drilling fluid may then be returned to the mud pit 334, where such fluid is filtered. In some embodiments, the drilling fluid can be used to cool the drill bit 326, as well as to provide lubrication for the drill bit 326 during drilling operations. Additionally, the drilling fluid may be used to remove subsurface formation 214 cuttings created by operating the drill bit 326.

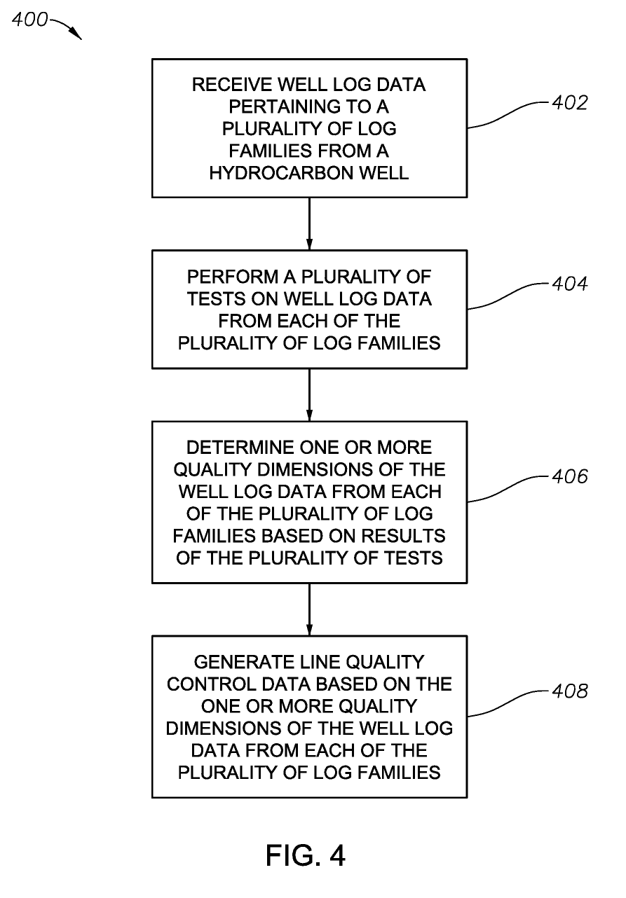

In some embodiments, a system 200, 300 can include a display 296 to present quality control charts as discussed in the following paragraphs with respect to FIGS. 4-9. The systems 200, 300 can also include computation logic, perhaps as part of a surface logging facility 292, or a computer workstation 254, to receive signals from transducers, receivers, and other instrumentation to determine properties of the formation 214 and to transform sensor data that has been acquired.

FIG. 4 illustrates example operations in an example method 400 for performing quality control analysis, according to one or more example embodiments of the disclosure. The example operations illustrated in FIG. 4 may be executed by one or more processors 130, 161, and the computer program comprising the computer instructions to execute these operations may be stored in one or more memory devices 150, 162 as illustrated in FIG. 1, for example. The method 400 for monitoring data quality of well log data from a hydrocarbon well may include at operation 402 receiving, by one or more processors 130, 161 coupled to a control unit 100 associated with the hydrocarbon well, well log data pertaining to a plurality of log families from the hydrocarbon well. The method 400 may also include the operation 404 of performing a plurality of tests on the well log data from each of the plurality of log families. The method may also include determining one or more quality dimensions of the well log data from each of the plurality of log families based on results of the plurality of tests at operation 406. The method may further include at operation 408 generating line quality control data based on the one or more quality dimensions of the well log data from each of the plurality of log families.

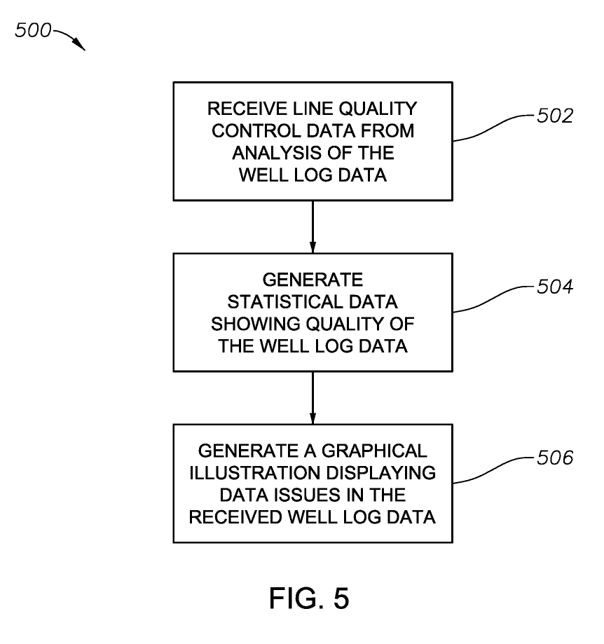

FIG. 5 illustrates example operations in an example method 500 for performing quality control analysis, according to one or more example embodiments of the disclosure. The method may include, in addition to the above example operations, receiving the line quality control data from analysis of the well log data at operation 502, and generating statistical data showing quality of the well log data at operation 504. The method may also include generating a graphical illustration displaying data issues in the received well log data at operation 506. The well log data may include at least one of wireline log data and logging-while-drilling log data. The plurality of tests may include a single log analysis or a cross-log analysis of the received well log data. The single log analysis may include at least one of a range analysis, a spike analysis, a bad hole analysis, a repeated values analysis, an excessive correction analysis, a missing values analysis, and a rugosity analysis. The cross-log analysis may include at least one of an order of logs analysis, an availability of combination of logs analysis, and a composite log validation analysis. The plurality of log families may include a value from a neutron log, a sonic log, a gamma ray log, a resistivity log, or a density log. The one or more quality dimensions may include at least one of completeness, consistency, validity, integrity, and availability.

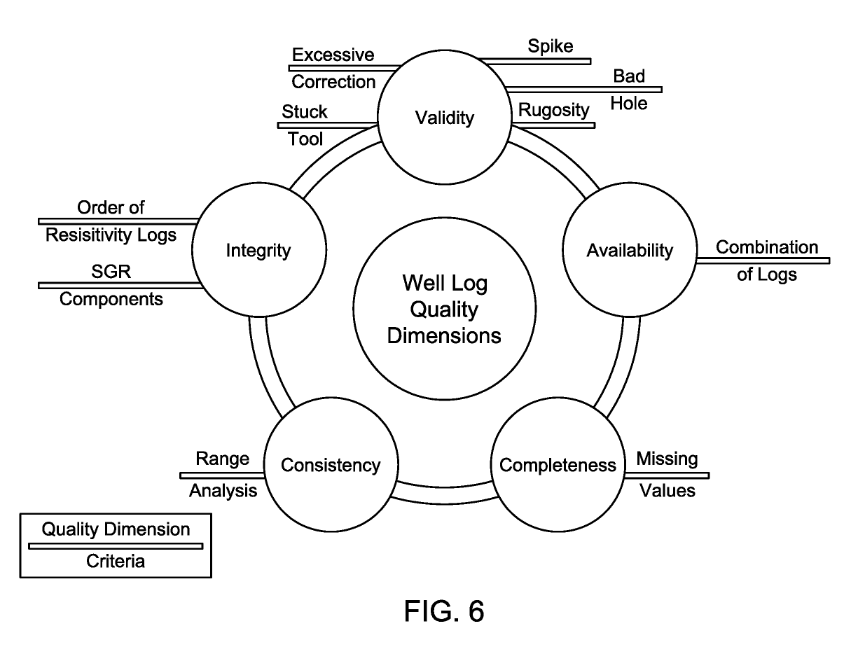

FIG. 6 illustrates a data quality dimension model adopted in a data quality check, according to one or more example embodiments of the disclosure. This method may save the petrophysicist time and resources, provides the petrophysicist with relevant information about the data quality by highlighting issues, displaying statistical charts, and measuring data quality quantitatively. Example methods and systems disclosed also help improve the final product quality by applying quality control filters in a systematic way, and aids less experienced petrophysicists in log quality control.

The above example methods can be implemented as software to highlight quality issues and provide statistical information about data quality. The system receives well log data as input, performs quality control, generates dynamically visual layouts highlighting data issues, and provides statistical information about well log data quality.

The systems and methods characterize well log data quality by a set of quality dimensions that include but not limited to availability, completeness, consistency, integrity, and validity. Consequently, the well log quality can be measured quantitatively as a function of these quality dimensions. According to some example embodiments, data is profiled using log analysis and cross-log analysis. In log analysis, all the log data samples are measured per unit depth and checked using predefined quality tests. In cross-log analysis, the log data samples of multiple logs are checked in parallel using the predefined tests. The quality tests of log and cross-log analysis profiling may not be applicable to all logging families. The mathematical formulas used to calculate the quality dimensions are illustrated below. According to some example embodiments, the average of these quality dimensions can be used to assess the overall quality of the log data set.

According to one example embodiment, the method may include two or more profiling methods, including for example a single log analysis and a multiple log analysis, for example, a cross-log profiling method. These profiling methods may be applied to log data from any log family, including but not limited to gamma ray logging, density logging, neutron logging, and resistivity logging. Additionally, each of these methods may be used for wireline logs as well as logging-while-drilling logs.

Under a single log analysis, a variety of tests may be conducted for determining each quality dimension of the log data. For example, a range analysis may include determining if a log sample value in the log data is within a predetermined range. The range may be determined based on many factors such as operational tool limits, natural limits, and formation knowledge. Alternatively or in addition, a spike analysis may include a statistical approach to identify a spike value using, for example, an upper control limit and a lower control limit. Alternatively or in addition, a bad hole analysis may be performed by subtracting the bit size from a caliper log. The differential hole size may indicate a bad hole condition that may affect logging if the value is outside a predetermined range. Alternatively or in addition, a repeated values analysis may be performed to determine the values of a log sample are not repeated in sequence. The sequential repetition of values may be an indication of stuck tool or defaulted values. Repeated values can be detected using a moving window method, for example. Alternatively or in addition, an excessive correction analysis may include marking a log sample as invalid if the log sample is beyond a predefined range. Alternatively or in addition, a missing values analysis may be performed to ensure that the continuity of log values must be maintained. Alternatively or in addition, a rugosity analysis may reflect the rapid changes with depth and roughness of the borehole.

Tests such as the range analysis, spike analysis, repeated values, and missing values may be applicable to all log families. However, the bad hole analysis and excessive correction analysis may be applicable to density. Similarly, the rugosity analysis may be applicable to neutron or density and resistivity log families. Tests such as the range analysis may be used to determine consistency, other tests including spike analysis, bad hole analysis, repeated values analysis, excessive correction analysis, and rugosity analysis may be used to determine validity, and missing values analysis may be used to determine completeness of the log, for example.

According to one example embodiment, cross-log analysis may include one or more tests including order of logs test, availability of combination of logs test, and a composite log validation test. An order of logs test may determine if the resistivity at different levels of depth of investigation must maintain an increasing or decreasing pattern. The order may be decided based on comparing the average values of the resistivity logs. An availability of the combination of logs may be determined—for each logging family there may be a minimum number of required logs to perform quality control. If the logging family availability is less than 100%, then quality control may not be applied and the issue may be highlighted. For example, for sonic, delta T may be highlighted, for neutron, neutron log and caliper may be highlighted, for gamma ray or corrected gamma, spectral gamma, Th, U, K may be highlighted, for density, photoelectric, caliper, and density correction may be highlighted, for resistivity, focused resistivity may be highlighted. For composite log validation, the spectral gamma ray (SGR) is compared against corrected gamma ray (CGR) where SGR must not be less than CGR. In this example, the order of logs analysis and composite log validation analysis may determine integrity, and availability of combination of logs analysis may determine availability. The order of logs analysis may be applicable to resistivity, availability of combination of logs analysis may be applicable to all families, and composite log validation analysis may be applicable to gamma ray logs.

The above example methods may be applied to both wireline logs as well as loggin-while-drilling (LWD) logs. However, the predetermined range for each of the log families may be different for wireline logs and LWD logs. For example, for a neutron log in a wireline log, a valid value may be in the range of about 0.05 to about 0.42 v/v, and the log may have rugosity if the rugosity value is greater than about 0.8, for example. However, in a LWD log, the value may be considered a valid value if it is in the range of about −0.02 to about 0.42 v/v, and the log may have rugosity if the rugosity value is greater than about 1, and any interpolated interval may be less than about 5 ft.

According to one example embodiment, the sonic log value for a wireline log may be considered a valid value if it is in the range of about 41 to about 160 μs/ft, and in the range of about 41 to about 160 μs/ft for a LWD log and no persistent collar arrivals, and any interpolated interval may be less than about 5 ft. For gamma ray logs, a wireline log may be considered a valid value if it is in the range of about 0 to about 1000 gAPI and if SGR is greater than or equal to CGR, if both values exist. For a LWD log, a gamma ray log may be considered a valid value if it is in the range of about 0 to about 1000 gAPI, and total GR is greater than or equal to SGR, and any interpolated interval is less than about 5 ft. For resistivity logs, a wireline log may be considered a valid value if the MSFL value is in the range of about 0.2 to about 200 ohm-m, induction is in the range of about 0.2 to about 1000 ohm-m and laterlog in the range of about 1 to about 2000 ohm-m, and may be considered to have rugosity if the rugosity is over about 0.8 for MSFL, and order of logs with different DOI must be maintained. For LWD logs, the laterlog micro-resistivity data may be considered valid if it falls within a valid measurement range of about 0.1 to about 2000 ohm-m, and may be considered to have rugosity if the rugosity is over about 0.8. The bottom hole assembly (BHA) may be rotating and not sliding, and the propagation resistivity data may be considered to be within a valid measurement range if phase shift falls within the range of about 0.1 to about 2000 ohm-m and attenuation falls within the range of about 0.1 to about 200 ohm-m. The multi-spacing measurement profile may be considered valid if it is consistent with the expected filtrate invasion, anisotropys, and proximal shoulder bed effects, and any interpolated interval is less than about 5 ft.

For wireline logs, a density log may be considered a valid value if the DRHO value is in the range of about −0.03 to about 0.15 gm/cc, PEF is in the range of about 1.6 to about 5.5 gm/cc, RHOB is in the range of about 2 to about 3.1 gm/cc, and CAL-BitSize is in the range of about −0.3 to about 2, and may be considered to have rugosity if the rugosity value is greater than about 0.8. The RHOB quality may depend on the RHOB readings in addition to the DRHO readings. For LWD logs, the density log may be considered a valid value if the RHOB value falls within the range of about 2.00 to about 3.10 g/cc, and the DRHO value falls within the range of about −0.03 to about 0.10 g/cc², and PEF falls within the range of about 1.6 to about 5.5 b/e. The log data may be considered to have rugosity if the rugosity value is greater than about 0.8. The BHA may be rotating and not sliding, and any interpolated interval may be less than about 5 ft. The caliper data may fall within the valid measurement range of about BS to about BS+3.5 inches, such that the difference between caliper and BS may be greater than or equal to about −0.2 inches.

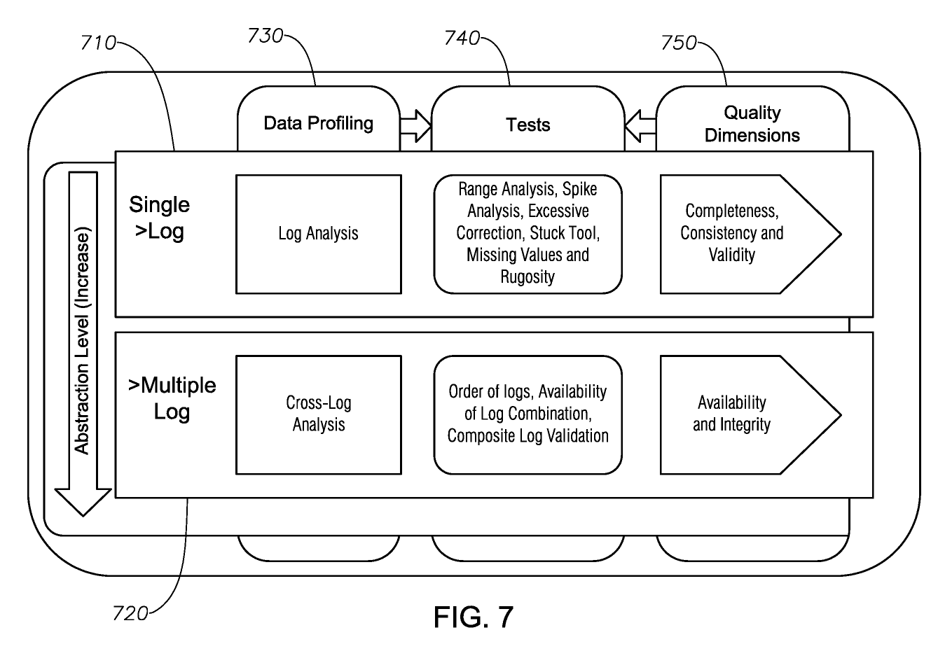

FIG. 7 illustrates different levels of data on which data quality tests may be applied, according to one or more example embodiments of the disclosure. In some embodiments, this method includes checking the data quality of conventional wireline and LWD well log data and reporting back to the user areas of concern to be addressed by the petrophysicist. Well log data quality may be characterized by a set of dimensions that include availability, completeness, consistency, integrity and validity. Consequently, the well log quality can be measured quantitatively as a function of these dimensions. For that, data is profiled using single log analysis 710 and multiple or cross-log analysis 720. This may also include data profiling 730, performing a plurality of tests 740, and determining one or quality dimension of the well log data 750. In log analysis, all the log data samples measured per unit of depth is checked using predefined quality tests. In cross-log analysis, the log data samples of multiple logs are checked in parallel using the predefined tests. The quality tests of log and cross-log profiling may not applicable to all logging families. The mathematical formulations used to calculate the quality dimensions are shown below. The average of these quality dimensions can be used to assess the overall quality of the log dataset.

$$\begin{matrix}Log Completness = 100 * [ 1 - \frac{Count ( Missing Values )}{N} ] & ( 1 ) \\ Log Consistency = 100 * [ 1 - \frac{Count ( Out of Range Values )}{N} ] & ( 2 ) \\ Gamma Ray Integrity = 100 * [ 1 - \frac{Count ( SGR < CGR )}{N} ] & ( 3 ) \\ Resisitvity Integrity = 100 * \frac{ \begin{matrix}Count ( Maintained Increasing or \\ Decreasing Resistivity Pattern )\end{matrix}}{N} & ( 4 ) \\ Log Validity = 100 * [ 1 - \frac{Count ( Spike )}{N} - \frac{Count ( Sequential Repeated Values )}{N} ] & ( 5 ) \\ Density Validity = Log Validity - 100 * [ \frac{Count ( \begin{matrix}DRHO beyond Acceptable \\ Range\end{matrix} )}{N} - \frac{Count ( Rugosity beyond Acceptable Range )}{N} - \frac{Count ( Bad Hole )}{N} ] & ( 6 ) \\ Neutron or Focused Resistivity Validity = Log Validity - 100 * [ \frac{Count ( Rugosity beyond Acceptable Range )}{N} ] & ( 7 ) \\ Availability = 100 * [ \frac{Count ( Available QC Required Logs )}{L} ] \\ Total Quality = \frac{1}{Q} {\sum }_{i = 1}^{Q} {QD}_{i} & ( 8 )\end{matrix}$$

Where
SGR is Spectral Gamma Ray
CGR is Corrected Gamma Ray
N is the number of log samples per unit of depth. For multiple logs, N is number of samples for the log with the least number of samples.
L is number of QC required logs.
Q is the number of quality dimensions
QDᵢ is quality dimension i

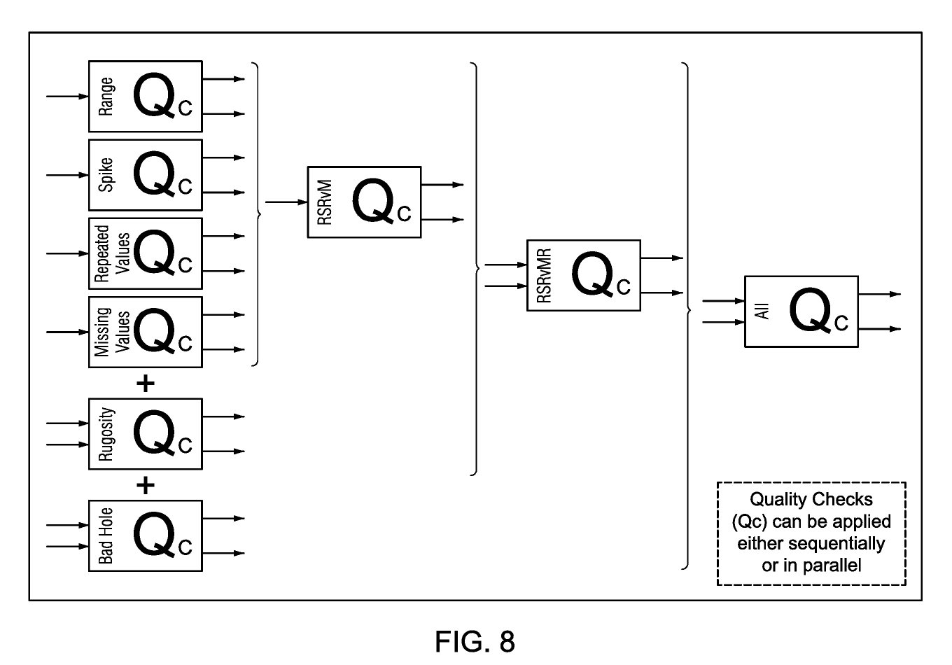

FIG. 8 illustrates the representation of composite quality checks, according to one or more example embodiments of the disclosure. The different quality checks can be grouped and represented as shown in this figure. There may be five different logging families that can be targeted, including sonic, neutron, resistivity, density, and gamma ray, as explained in the above example embodiments. The general form of quality check involves receiving an input value, performing a quality control analysis on the input value, and generating an output value.

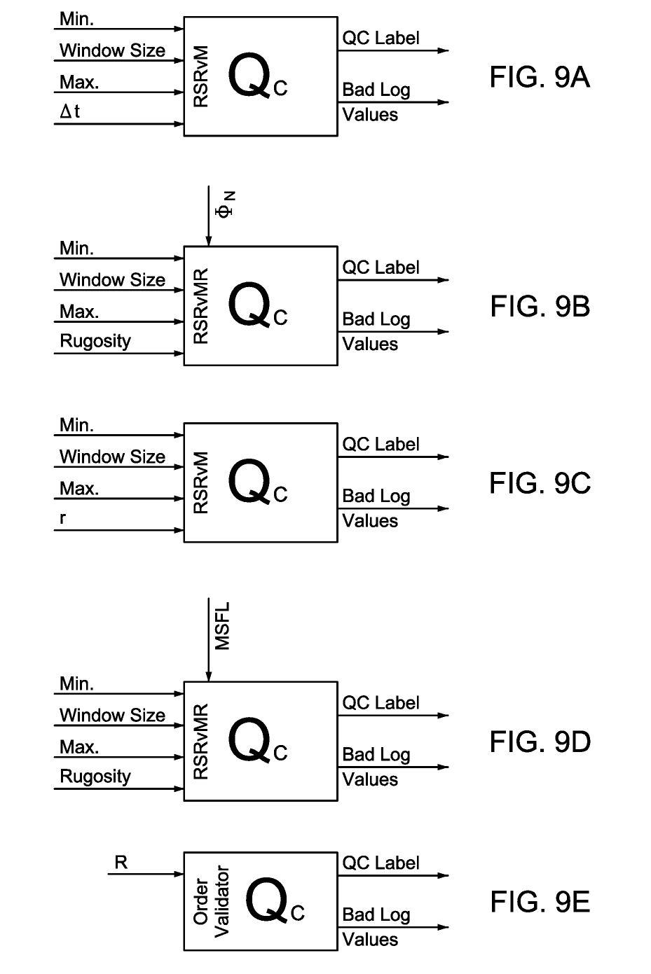

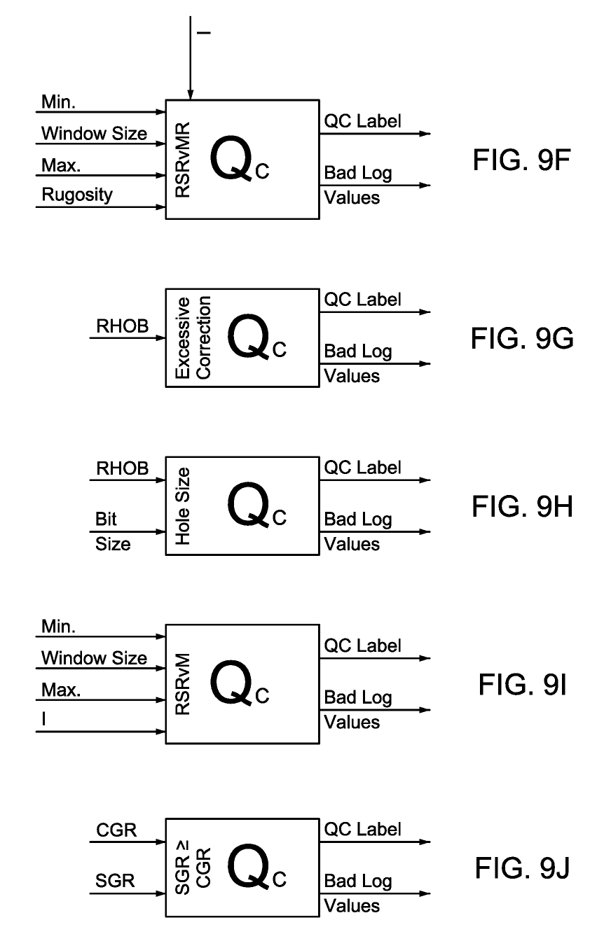

FIG. 9A, for example, illustrates sonic logging quality checks, according to one or more example embodiments of the disclosure. FIG. 9B illustrates neutron logging quality checks, according to one or more example embodiments of the disclosure. FIGS. 9C-E illustrate resistivity logging quality checks, according to one or more example embodiments of the disclosure. FIG. 9C illustrates the quality control parameters for all resistivity logs r except micro spherical focused logs, FIG. 9D illustrates the quality control parameters for only micro spherical focused logs, and FIG. 9E illustrates the quality control parameters for a vector of resistivity logs R, applying log order quality check, according to one embodiment.

FIGS. 9F-H illustrate density logging quality checks, according to one or more example embodiments of the disclosure. FIG. 9F illustrates the quality control parameters for all logs Iε{PEF, RHOB}, FIG. 9G illustrates the quality control parameters for a RHOB log, applying an excessive correction quality check, and FIG. 9H illustrates the quality control parameters for a RHOB log, applying a hole size quality check, according to one embodiment.

FIGS. 9I-J illustrate gamma ray logging quality checks, according to one or more example embodiments of the disclosure. FIG. 9I illustrates the quality control parameters for all logs Iε{GR, TH, U, K}, and FIG. 9J illustrates the quality control parameters for CGR and SGR logs, provided SGR≧CGR, according to one embodiment.

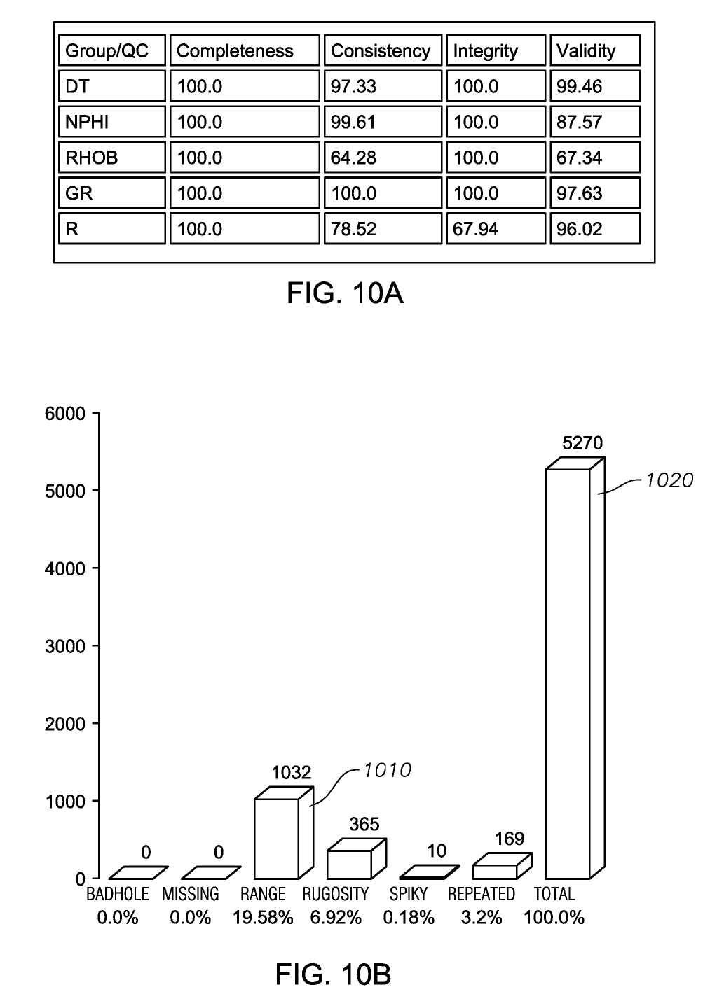

FIG. 10A illustrates data quality dimension measurements in well logging groups, according to one or more example embodiments of the disclosure. As illustrated in this table, each quality dimension of each of the log of families may be rated on a scale of 100.0, and the combined value of line quality control data may be determined, for example, on a weighted average value of each of the quality dimension of each of the log of families.

FIG. 10B illustrates a histogram showing data quality issues with microspherical focused resistivity log data, according to one or more example embodiments of the disclosure. As illustrated in this example, the microspherical focused resistivity log data shows a range analysis result of 19.58%, rugosity of 6.92%, spiky values of 0.18%, repeated values or stuck tool indication of 3.2%.

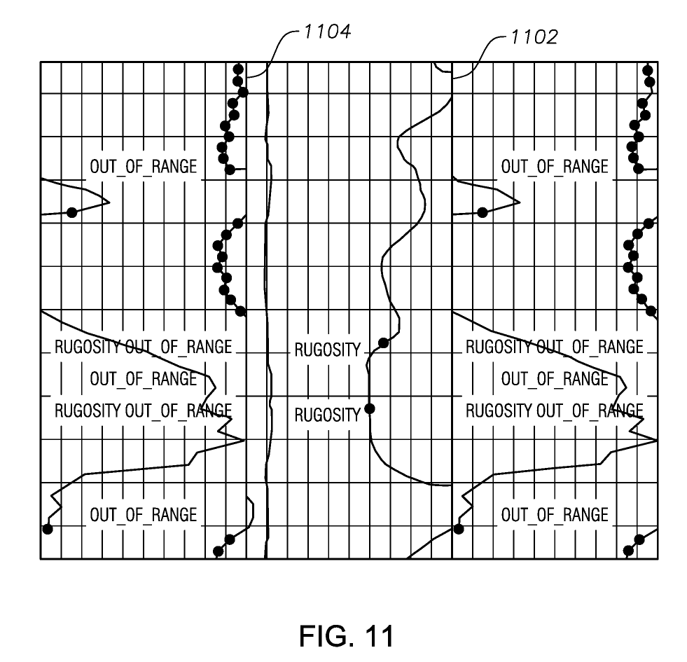

FIG. 11 illustrates a visual layout of well logs with quality issues, according to one or more example embodiments of the disclosure. As seen here, the rugosity of the well log data may be considered valid if it falls within a range as defined by limits 1102 and 1104. If the rugosity of the well log data falls beyond these predetermined values, then the rugosity value may be considered affected. An example upper limit for rugosity value for this example embodiment is 0.8. Accordingly, if the rugosity value is greater than 0.8, then the rugosity may be considered affected.

Some advantages of the example methods and systems disclosed herein include the reduction or elimination of operational costs of errors associated with manual well log data quality control. Additionally, the process of petrophysical log quality control may be standardized using the example methods disclosed herein. The example methods and systems also prevent the propagation of data errors into log interpreted products as the processed well log data is the final product used by different departments for many important decisions and computations.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A quality control system for monitoring data quality of well log data from a hydrocarbon well, the system comprising:
one or more processors operatively coupled to a control unit associated with the hydrocarbon well; and
a non-transitory computer-readable medium in communication with the one or more processors and having stored thereon a set of instructions that when executed cause the one or more processors to perform operations comprising:
receiving well log data pertaining to a plurality of log families from the hydrocarbon well;
performing a plurality of tests on well log data from each of the plurality of log families;
determining one or more quality dimensions of the well log data from each of the plurality of log families based on results of the plurality of tests; and
generating line quality control data based on the one or more quality dimensions of the well log data from each of the plurality of log families.

2. The system of claim 1, wherein the instructions further cause the one or more processors to perform operations comprising:
receiving the line quality control data from analysis of the well log data; and
generating statistical data showing quality of the well log data.

3. The system of claim 1, wherein the instructions further cause the one or more processors to perform operations comprising:
generating a graphical illustration displaying data issues in the received well log data.

4. The system of claim 1, wherein the well log data comprises at least one of wireline log data and logging-while-drilling log data.

5. The system of claim 1, wherein the plurality of tests comprises a single log analysis or a cross-log analysis of the received well log data.

6. The system of claim 5, wherein the single log analysis comprises at least one of a range analysis, a spike analysis, a bad hole analysis, a repeated values analysis, an excessive correction analysis, a missing values analysis, and a rugosity analysis.

7. The system of claim 5, wherein the cross-log analysis comprises at least one of an order of logs analysis, an availability of combination of logs analysis, and a composite log validation analysis.

8. The system of claim 1, wherein the plurality of log families comprise a value from a neutron log, a sonic log, a gamma ray log, a resistivity log, or a density log.

9. The system of claim 1, wherein the one or more quality dimensions comprise at least one of completeness, consistency, validity, integrity, and availability.

10. A method for monitoring data quality of well log data from a hydrocarbon well, the method comprising:
receiving, by one or more processors coupled to a control unit associated with the hydrocarbon well, well log data pertaining to a plurality of log families from the hydrocarbon well;
performing a plurality of tests on well log data from each of the plurality of log families;
determining one or more quality dimensions of the well log data from each of the plurality of log families based on results of the plurality of tests; and
generating line quality control data based on the one or more quality dimensions of the well log data from each of the plurality of log families.

11. The method of claim 10, further comprising:
receiving, by the one or more processors, the line quality control data from analysis of the well log data; and
generating statistical data showing quality of the well log data.

12. A non-transitory computer-readable medium including instructions stored thereon, which when executed by one or more processors operatively coupled the computer-readable medium, cause the one or more processors to perform operations comprising:
receiving well log data pertaining to a plurality of log families from a hydrocarbon well;
performing a plurality of tests on well log data from each of the plurality of log families;
determining one or more quality dimensions of the well log data from each of the plurality of log families based on results of the plurality of tests; and
generating line quality control data based on the one or more quality dimensions of the well log data from each of the plurality of log families.

13. The medium of claim 12, wherein the instructions further cause the one or more processors to perform operations comprising:
receiving the line quality control data from analysis of the well log data; and
generating statistical data showing quality of the well log data.

14. The medium of claim 12, wherein the instructions further cause the one or more processors to perform operations comprising:
generating a graphical illustration displaying data issues in the received well log data.

15. The medium of claim 12, wherein the well log data comprises at least one of wireline log data and logging-while-drilling log data.

16. The medium of claim 12, wherein the plurality of tests comprises a single log analysis or a cross-log analysis of the received well log data.

17. The medium of claim 16, wherein the single log analysis comprises at least one of a range analysis, a spike analysis, a bad hole analysis, a repeated values analysis, an excessive correction analysis, a missing values analysis, and a rugosity analysis.

18. The medium of claim 16, wherein the cross-log analysis comprises at least one of an order of logs analysis, an availability of combination of logs analysis, and a composite log validation analysis.

19. The medium of claim 12, wherein the plurality of log families comprise a value from a neutron log, a sonic log, a gamma ray log, a resistivity log, or a density log.

20. The medium of claim 12, wherein the one or more quality dimensions comprise at least one of completeness, consistency, validity, integrity, and availability.
